(19) United States
(12) Patent Application Publication
(10) Pub. No.: US 2003/0115722 A1
(43) Pub. Date: Jun. 26, 2003

(54) Clip with contact plates

(76) Inventors: Ladi O. Shogbamimu, Leawood, KS (US); Dennis B. Danella, Lenexa, KS (US)

Correspondence Address: LADI O. SHOGBAMIMU, 2106 WEST 121st STREET, LEAWOOD, KS, 66209, US

(21) Appl. No.: 10/244,497

(22) Filed: Sep. 16, 2002

Related U.S. Application Data
(63) Continuation-in-part of application No. 29/152,668, filed on Dec. 21, 2001, now Pat. No. D468355.

(51) Int. Cl. B42F 1/00

(52) U.S. Cl. 24/67 R; 24/67.3; 24/67.5

(57) ABSTRACT

A binder clip that is capable of fastening a plurality of objects together while reducing the amount of damage thereto is provided. The binder clip includes a mouth, a pair of arms and first and second contact plates. The mouth includes first and second outer edges that are biased toward one another. The pair of arms are pivotally coupled with the mouth and are used to open the mouth. The first and second contact plates may be coupled with first and second outer edges. The mouth biases the first and second plates toward each other to hold the object together. The first and second plates operate to distribute the force imposed by the mouth thereby reducing the amount of damage to the one or more objects.

### CROSS-REFERENCE TO RELATED APPLICATIONS

This application is a continuing application of U.S. Design application Ser. No. 29/152,668, filed Dec. 21, 2001.

### STATEMENT REGARDING FEDERALLY SPONSORED RESEARCH OR DEVELOPMENT

Not Applicable.

### BACKGROUND OF THE INVENTION

The present invention relates to a binder clip. In particular, the present invention relates to a binder clip having at least one plate that operates to reduce the amount of damage to an object when the binder clip is coupled thereto.

It is well known that various types of fasteners may be used in a wide variety of office and administrative applications. For instance, it is common to use a paper clip, staple or binder clip to fasten two or more sheets of paper together. Typically, a binder clip is used when a plurality of papers need to be temporarily fastened to one another. Specifically, the arms of the binder clip are squeezed towards each other to open the mouth a sufficient distance to accept the stack of papers to be fastened together. The papers are then inserted between the opposed clasps of the binder clip and the arms are released. The outer edges of the claps are biased toward each other to apply the necessary force to hold the papers together.

These prior art binder clips suffer from a number of drawbacks and deficiencies. For instance, the force imposed by the outer edge of the clasps causes damage to the paper. Specifically, the binder clip forms indentations in the top and bottom few pieces of paper where the outer edges of the clasps came into contact with the paper. The indentations are readily apparent after the binder clip is removed from the stack of papers the indentations take away from the clean and finished look of the paper.

Accordingly, there exists a need for a binder clip that reduces the amount of damage imposed on a piece of paper while keeping a plurality of papers fastened together. The present invention fills these needs as well as various other needs.

### BRIEF SUMMARY OF THE INVENTION

In order to overcome the above-stated problems and limitations, and to achieve the noted objects, there is provided a binder clip that is capable of fastening a plurality of papers together while reducing the amount of damage to those papers.

In general, the binder clip includes a mouth, a pair of arms and a first contact plate. The mouth includes first and second outer edges that are biased toward one another. The pair of arms are pivotally coupled with the mouth and are used to open the mouth. The first contact plate may be coupled with either the first or second outer edge of the mouth. In use, the arms open the mouth of the clip to accept the object. Once the arms are released, the first and second outer edges of the mouth apply a force to hold onto the one or more objects together. The first contact plate operates to distribute the force imposed by the outer edge that it is coupled to thereby reducing the amount of damage to the object.

Additionally, the clip may include a second contact plate that is coupled with the second outer edge of the mouth to distribute the force imposed by the second outer edge to further reduce the amount of damage to the object. In addition, the first and second contact plates may be hingedly coupled with first and second outer edges of the mouth.

Further objects, features, and advantages of the present invention over the prior art will become apparent from the detailed description of the drawings which follows, when considered with the attached figures.

### BRIEF DESCRIPTION OF THE SEVERAL VIEWS OF THE DRAWINGS

In the accompanying drawings which form a part of the specification and are to be read in conjunction therewith and in which like reference numerals are employed to indicate like parts in the various views:

FIG. 1 is a perspective view showing a clip having a pair of arms, a mouth and a pair of contact plates according to the present invention;

FIG. 2 is a bottom plan view of the clip shown in FIG. 1;

FIG. 3 is a side elevational view of the clip shown in FIG. 1;

FIG. 4 is a cross-sectional view taken along line 4-4 in FIG. 2;

FIG. 5 is a cross-sectional view similar to FIG. 4 with parts broken away showing an alternative embodiment where the contact plates are hingedly coupled to the mouth of the clip; and

FIG. 6 is a cross-sectional view similar to FIG. 5 showing the contact plates in phantom lines to illustrate the pivotal movement with respect to the mount of the clip.

### DETAILED DESCRIPTION OF THE INVENTION

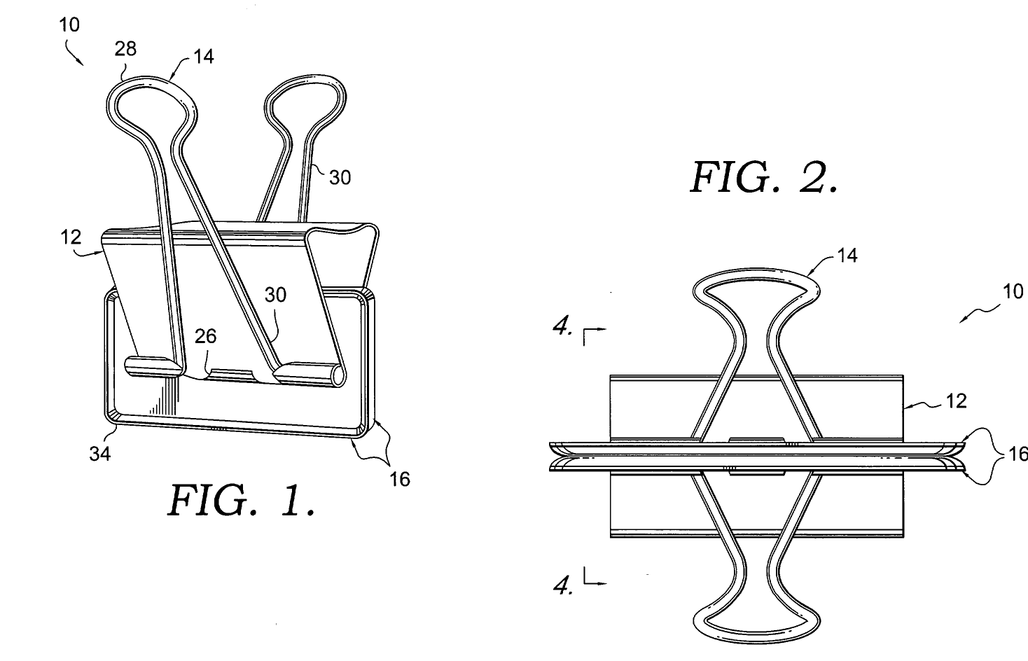

Referring now to the drawings in detail, and initially to FIG. 1, numeral 10 generally designates a clip constructed in accordance with a first preferred embodiment of the present invention. Clip 10 may include a mouth 12 having a pair of arms 14 pivotally coupled thereto. A pair of plates 16 are coupled with mouth 12 and are used to contact one or more object to be fastened together by clip 10.

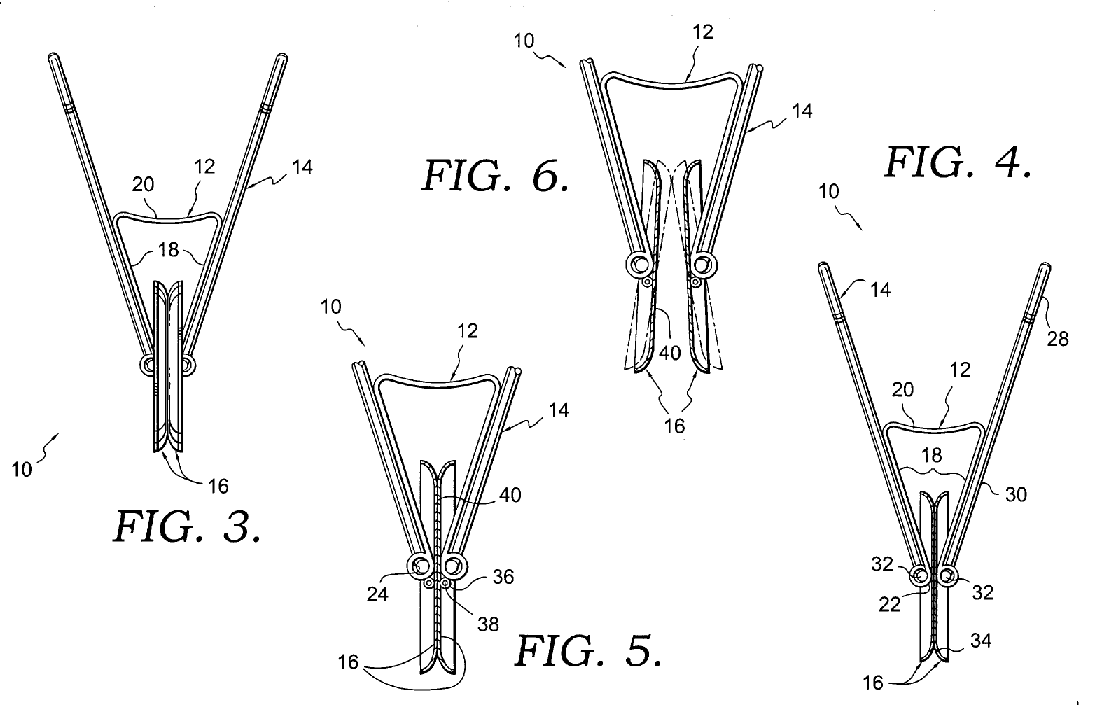

As best seen in FIG. 3, mouth 12 includes a pair of opposed side clasps 18 coupled to one another by a rear wall 20. As best seen in FIGS. 1 and 4, side clasps 18 may be integrally formed with rear wall 20 and provide for an outer edge 22. A portion of outer edge 22 is curled outwardly to form a channel 24. With specific reference to FIG. 1, a portion of outer edge 22 may have a slot 26 defined therein to allow arms 14 to move between an open position (FIG. 1) and a closed position which will be discussed in further detail below.

As best seen in FIGS. 1 and 4, each of arms 14 include a loop portion 28, intermediate section 30 and a pair of end portions 32. Loops 28 may be positioned to allow a user to apply a force to open mouth 12 of clip 10. End portions 32 extend outwardly in opposite directions with respect to one another and are adapted to fit within channel 24. Therefore, arms 14 are pivotally coupled with mouth 14 and may be moved between opened and closed positions. As best seen in FIG. 1, arms 14 may be placed in an open position when a user wants to open mouth 12 to place one or more objects between side clasps 18. Further, arms 14 may be placed in a closed position by rotating loops 28 about end portions 32 where intermediate section 30 moves through slot 26 so that arms 14 may rest against the object.

As best seen in FIGS. 1 and 4, plates 16 are coupled with mouth 12 in a location to come into contact with the one or more objects to be fastened together. With additional reference to FIG. 2, each plate 16 includes a peripheral edge 34 that may be bent or crimped outwardly relative to the opposite plate. However, it is also within the scope of this invention to provide for a peripheral edge that is generally flat so as to be coplanar with the remaining portion of plate 16. Furthermore, it will be understood that it is within the scope of the present invention to provide for plates 16 with various shapes and sizes. Moreover, it is within the scope of this invention to utilize only one plate 16 in conjunction with mouth 12 to accomplish the objectives of the invention. Plates 16 may be formed of various materials including, but not limited to, metal, plastic, felt, wood, rubber and any combination thereof.

As best seen in FIG. 4, one or more of plates 16 may be fixedly coupled with outer edge 22 of mouth 12. While a middle portion of plates 16 are shown to be coupled with outer edges 22, it will be understood and appreciated that any portion of plates 16 may be coupled with outer edges 22 of mouth 12. For instance, plate 16 may be coupled to outer edge 22 so that a substantial portion of plate 16 is positioned between side clasps 18. On the other hand, plate 16 may also be coupled to outer edge 22 so that a substantial portion of plate 16 is positioned outside of mouth 12. Further, as best seen in FIG. 5, plates 16 may also be hingedly coupled with mouth 12. In particular, a hinge 36 is fixedly coupled with said mouth 12 and has a pin 38 rotatably mounted therein. Pin 38 is fixedly mounted with plate 16 and allows plate 16 to rotate with respect to mouth 12 as illustrated in FIG. 6.

In use, clip 10 may be opened to accept one or more objects and apply the necessary force to hold the objects together. To open clip 10, arms 14 are placed in a position as shown in FIG. 1. Loop portions 28 are then squeezed toward each other thereby operating as a lever rotating about the point where intermediate section 30 is in contact with mouth 12. The lever action of loop portions 28 cause end portions 32 and plates 16 to move away from each other. At this point, one or more objects may be placed within mouth 12. The loop portions 28 are then released and the bias of side clasps 18 cause outer edges 22 and plates 16 to move toward the one or more objects. A contact surface 40 on each of plates 16 presses against the objects to hold them together within mouth 12. As best seen in FIG. 6, if plates 16 are hingedly coupled with mouth 12, plates 16 may rotate to aid in placing the one or more objects within mouth 12, adapt to the surface of the one or more objects, and for other reasons.

It can, therefore, be seen that the invention is one that is designed to overcome the drawbacks and deficiencies existing in the prior art. The invention provides a clip having one or more contact plates that are used to reduce the amount of damage to the objects being held by the clip. The contact plates reduce the damage to the objects being held together by increasing the contact surface area between the clip and the object thereby distributing the force imposed by the clip.

While particular embodiments of the invention have been shown, it will be understood, of course, that the invention is not limited thereto, since modifications may be made by those skilled in the art, particularly in light of the foregoing teachings. Reasonable variation and modification are possible within the scope of the foregoing disclosure of the invention without departing from the spirit of the invention.

What is claimed is:

1. A clip for holding one or more objects together, said clip comprising:
a mouth;
means for closing said mouth; and
a first plate coupled with said mouth,
wherein said mouth is closed to hold onto the one or more objects, and wherein said first plate is positioned between said mouth and the one or more objects to reduce the amount of damage imposed on the one or more objects.

2. The clip of claim 1, wherein said first contact plate is hingedly coupled with said mouth.

3. The clip of claim 1, wherein said first contact plate includes a peripheral edge, wherein at least a portion of said peripheral edge is bent outwardly.

4. The clip of claim 1, further comprising:
a second contact plate coupled with said mouth, wherein said second contact plate distributes the force imposed by said mouth to reduce the amount of damage to the object.

5. The clip of claim 4, wherein said first and second contact plates are hingedly coupled with said mouth.

6. The clip of claim 4, wherein said first and second contact plates each include a peripheral edge, wherein said peripheral edge is bent outwardly.

7. The clip of claim 4, wherein said first and second contact plates are formed of a material selected from the group consisting of metal, felt, rubber, plastic, wood and any combination thereof.

8. The clip of claim 1, wherein said mouth further comprises:
a rear wall; and
a pair of side clasps coupled to one another by said rear wall.

9. The clip of claim 1, further comprising a pair of arms coupled with said mouth, wherein said arms are used to open said mouth.

10. A clip for holding one or more object together, said clip comprising:
a mouth having first and second outer edges, wherein said first and second outer edges are biased toward one another,
a pair of arms coupled with said mouth; and
a first contact plate coupled with said first outer edge of said mouth,
wherein said arms open said mouth to accept the object, wherein said first and second outer edges of said mouth apply a force to hold the one or more objects together, and wherein said first contact plate distributes the force imposed by said first outer edge to reduce the amount of damage to the object.

11. The clip of claim 10, wherein said first contact plate is hingedly coupled with said first outer edge of said mouth.

12. The clip of claim 10, wherein said first contact plate includes a peripheral edge, wherein at least a portion of said peripheral edge is bent outwardly.

13. The clip of claim 10, further comprising:
a second contact plate coupled with said second outer edge, wherein said second contact plate distributes the force imposed by said second outer edge to reduce the amount of damage to the object.

14. The clip of claim 13, wherein said first contact plate is hingedly coupled with said first outer edge, and wherein said second contact plate is hingedly coupled with said second outer edge.

15. The clip of claim 13, wherein said first and second contact plates each include a peripheral edge, wherein said peripheral edge is bent outwardly.

16. The clip of claim 13, wherein said first and second contact plates are formed of a material selected from the group consisting of metal, felt, rubber, plastic and any combination thereof.

17. The clip of claim 10, wherein said mouth further comprises:
a rear wall; and
a pair of side clasps coupled to one another by said rear wall.

18. The clip of claim 10, wherein said arms are hingedly coupled with said mouth.

19. A clip for holding one or more object together, said clip comprising:
a mouth;
means for supplying the necessary force to hold the object within said mouth; and
means for distributing the force applied to the object over a larger surface area to reduce the amount of damage to the object.
